(19) United States
(12) Patent Application Publication
(10) Pub. No.: US 2004/0166865 A1
(43) Pub. Date: Aug. 26, 2004

(54) Call recovery using multiple access call recovery channel

(76) Inventors: Anthony C.K. Soong, Superior, CO (US); Thawatt Gopal, San Diego, CA (US); Rath Vannithamby, San Diego, CA (US); Seong-Jun Oh, San Diego, CA (US); David Comstock, San Diego, CA (US)

Correspondence Address: COATS & BENNETT, PLLC, P O BOX 5, RALEIGH, NC, 27602, US

(21) Appl. No.: 10/728,218

(22) Filed: Dec. 4, 2003

Related U.S. Application Data
(60) Provisional application No. 60/431,363, filed on Dec. 6, 2002.

(51) Int. Cl. H04Q 7/20

(52) U.S. Cl. 455/450

(57) ABSTRACT

A call recovery method uses a multiple access forward call recovery channel to perform simultaneous rescues for multiple mobile stations. Rescue messages, such as handoff direction messages, for different mobile stations are multiplexed onto the call recovery channel for transmission to mobile stations in need of rescue.

### RELATED APPLICATIONS

This application claims priority under 35 U.S.C. § 119(e) from the following U.S. provisional application: Application Serial No. 60/431,363 filed on Dec. 6, 2002. That application is incorporated in its entirety by reference herein.

### BACKGROUND OF THE INVENTION

The cdma2000 standard includes a call recovery channel to recover calls in danger of being dropped. The mobile station disables its transmitter when it receives a predetermined number of consecutive bad frames-on the forward link. The base stations in the mobile station's active set, in turn, detect the loss of the signal from the mobile station. The mobile station and the base stations then execute a rescue procedure in order to reestablish the call before it is dropped.

Upon recognition that a mobile station has stopped transmitting, a base station sends a handoff request to a base station controller. The handoff request includes a flag that indicates that a call rescue procedure is requested. The BSC notifies nearby base stations with rescue capability to begin listening for the mobile station. After disabling its transmitter, the mobile station autonomously promotes one or more base stations from its neighbor list with rescue capabilities into its active set, re-enables its transmitter, and starts transmitting reverse traffic frames to the newly promoted base stations. The mobile station also transmits an extended pilot strength measurement message (EPSMM) identifying the newly-promoted base stations. If a rescue base station receives the EPSMM from the mobile station, it immediately begins forwarding forward traffic frames to the mobile station over a forward call recovery channel. The rescue base station also transmits the EPSMM received from the mobile station to the base station controller. The base station controller sends a handoff direction message to the mobile station based on the EPSMM to effect a handoff. The base station controller also sends a drop target message to all of the rescue base stations that were not autonomously promoted into the active set of the mobile station.

The current call recovery procedure does not allow for the rescue of multiple mobile stations at the same time. It is generally assumed that the probability of more than one mobile station requiring rescue is very small. Therefore only one channel is dedicated for call recovery. It is generally undesirable to have more than one rescue channel because the rescue channel is idle when there is no call to rescue. Thus, the rescue channels tie up resources that could otherwise be used to carry user traffic. Because the rescue resources are limited, it is undesirable to tie up the resources reserved for call recovery channel for calls that may not need rescuing. Accordingly, most systems are conservative in triggering a rescue procedure to prevent tying up the rescue resources for mobile stations not truly in need of rescue. Using a more liberal criterion to trigger the rescue procedure sooner would increase the speed of a call recovery, resulting in more efficient use of the resources and more calls rescued. Faster rescues also reduce interference on the forward and reverse links. A mobile station in danger of being dropped is likely to have a sub-optimal active set on the reverse link, which causes the mobile station to transmit with a higher transmit power than is necessary. Thus, the mobile station generates more interference on the reverse link. Similarly, a sub-optimal active set on the forward link causes the base stations serving the mobile station to transmit at higher power levels generating more interference on the forward link. The increase in interference on the forward and reverse links reduces system capacity.

### SUMMARY OF THE INVENTION

A call recovery method uses a multiple access forward call recovery channel to perform simultaneous rescues for multiple mobile stations. Rescue base stations multiplex rescue messages, such as handoff direction messages, for different mobile stations onto the call recovery channel for transmission to mobile stations in need of rescue. Rescue messages may be time multiplexed onto the call recovery channels, such that rescue messages for different mobile stations are transmitted in different time slots of the call recovery channel. Rescue messages may be covered by the mobile station's long code, which is unique to each mobile station, so the mobile stations can differentiate messages intended for them. In this case, it is not necessary to explicitly assign a time slot to a mobile station. Alternatively, the outcome of a hashing algorithm may be used to select the time slot for transmitting a rescue message to a particular mobile station.

Multiplexing rescue messages onto a multiple access call recovery channel allows for faster recovery of a mobile station in need of rescue because the network can execute multiple rescue attempts simultaneously. To further speed the recovery of mobile stations in danger of being dropped, a less conservative criteria can be employed to initiate a rescue procedure, since the rescue of a single mobile stations will not tie up all the rescue resources. Explicit signaling may be used to setup a rescue attempt before the mobile station stops transmitting. Because the rescue is setup before the mobile station requires rescue, the mobile station may switch immediately to a rescue base station when a predetermined criterion is reached without having to wait for the expiration of a timer.

In one embodiment, the mobile station monitors a frame error rate or other signal quality indicator. When the signal quality indicator reaches a first threshold, the mobile station transmits a message to a base station indicating that it may be in need of rescue. Upon receipt of the rescue message from the mobile station, the base station initiates a rescue procedure by notifying one or more rescue base stations to listen for the mobile station. When the signal quality indicator reaches a second threshold, the mobile station autonomously promotes one or more base stations with rescue capability from its neighbor list into its active set and begins transmitting to the newly-promoted base stations.

### BRIEF DESCRIPTION OF THE DRAWINGS

FIG. 1 is a functional block diagram of a mobile communication network in which the present invention may be implemented.

FIG. 2 is a functional block diagram of a base station in the mobile communication network.

FIG. 3 is a functional block diagram of a mobile station in the mobile communication network.

FIG. 4 is a call flow diagram illustrating an exemplary rescue procedure.

FIG. 5 is a timing diagram illustrating the operation of timers in the mobile station during execution of a rescue procedure.

FIG. 6 is a call flow diagram illustrating an exemplary rescue procedure for rescuing two mobile stations.

FIG. 7 is a call flow diagram illustrating an exemplary rescue procedure using a multiple access forward call recovery channel.

### DETAILED DESCRIPTION OF THE INVENTION

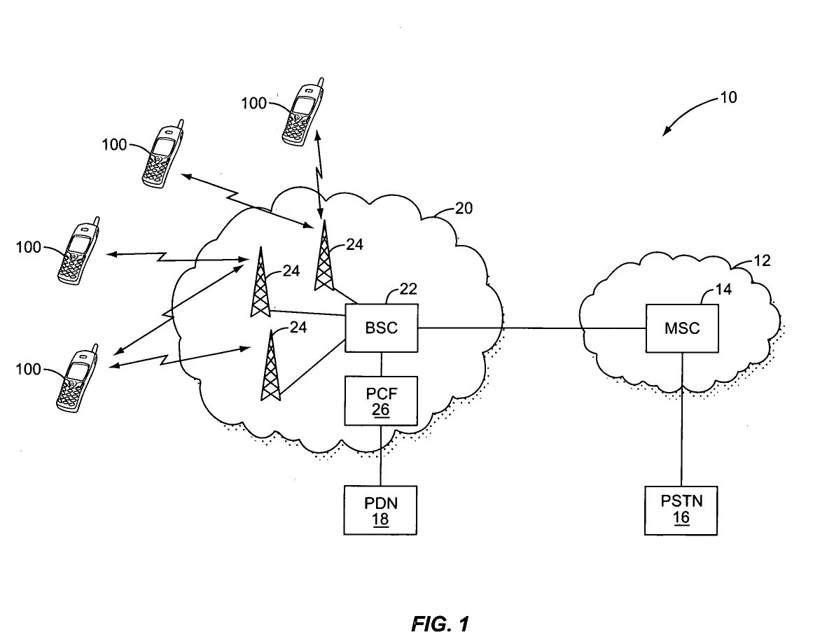

Referring now to FIG. 1, the present invention will be discussed in the context of a wireless communications network 10. The present invention was originally developed for use in CDMA networks and therefore the discussion will focus on CDMA communication networks 10 based on the cdma2000 standard. The present invention is particularly useful in systems based on the first EVolution (1×EV) of the cdma2000 standard, which includes both the 1×EV-DO (Data Only) and 1×EV-DV (Data and Voice) standards. However, the present invention could be adapted and employed in systems using other communication standards.

Network 10 comprises a circuit-switched core network 12 including at least one mobile switching center (MSC) 14 and one or more radio access networks (RANs) 20 operatively connected to the core network 12. Each RAN 20 comprises one or more base station controllers (BSCs) 22, one or more base transceiver stations (BTSs) 24, and a Packet Core Function (PCF) 26.

Each BTS 24 comprises a plurality of transmitters and receivers and can simultaneously handle calls from many mobile stations 100. Each BTS 24 is located in and provides service to a geographic region referred to as a cell. In general there is one BTS 24 in a cell, but a cell could include multiple BTSs 24. The cell may be a sectorized cell that is divided into a number of sectors. A single BTS 24 in a cell may serve all sectors in the cell.

The BSC 22 manages the communication resources for a plurality of BTSs 24 and coordinates the operations of multiple BTSs 24. The BSC 22 connects to the MSC 14 in the core network 12, typically via a telephone line or microwave link, and routes calls and signaling messages between the MSC 14 and the BTSs 24. The BSC 22 also reformats and multiplexes data passing between the BTSs 24 and the MSC 14. PCF 26 connects the RAN 20 to a PDN 18, such as the Internet, and routes packet data back and forth between the PDN 18 and BSC 22.

The MSC 14 connects to external wireline networks such as the Public Switched Telephone Network (PSTN) 16, the Integrated Services Digital Network (ISDN) and/or a Packet Data Network (PDN) 18, such as the Internet. The MSC 14 routes calls, via the BSC 22 and BTS 24, to the individual mobile stations 100.

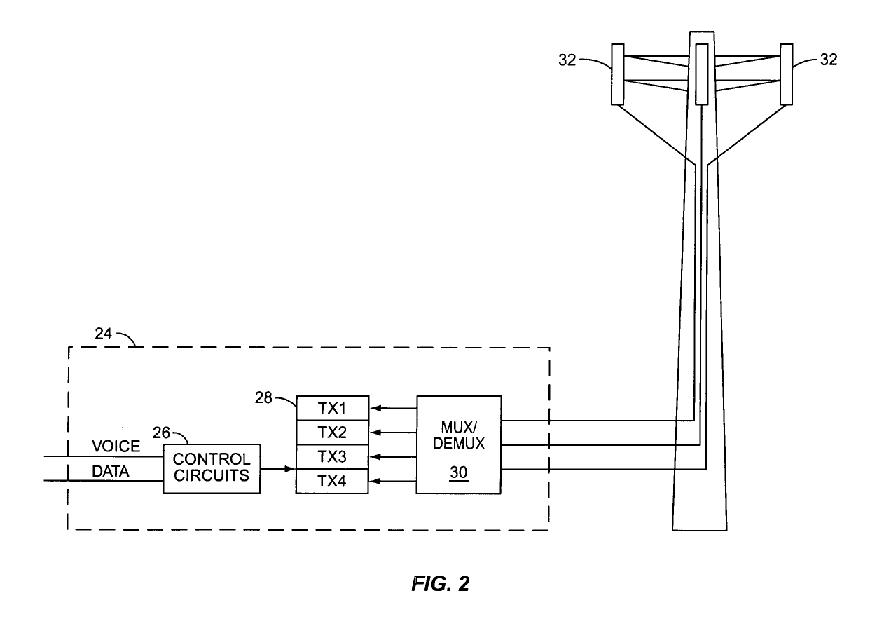

FIG. 2 is a functional block diagram of a base station 12. The base station 12 includes a control circuits 26, a transceiver array 28, multiplexer/demultiplexer 30, and one or more antennas 32. The transceiver array 202 comprises a plurality of transceivers, which may, for example, be CDMA transceivers. The transceivers are coupled by multiplexer 30 to transmit and receive antennas 32. Signals received by antennas 32 from mobile stations 100 are demultiplexed by multiplexer/demultiplexer 30 and fed to the transceivers in the transceiver array 24 for processing. Signals transmitted by the BTS 24 are combined by the multiplexer/demultiplexer 30 and transmitted by antennas 32 to mobile stations 100.

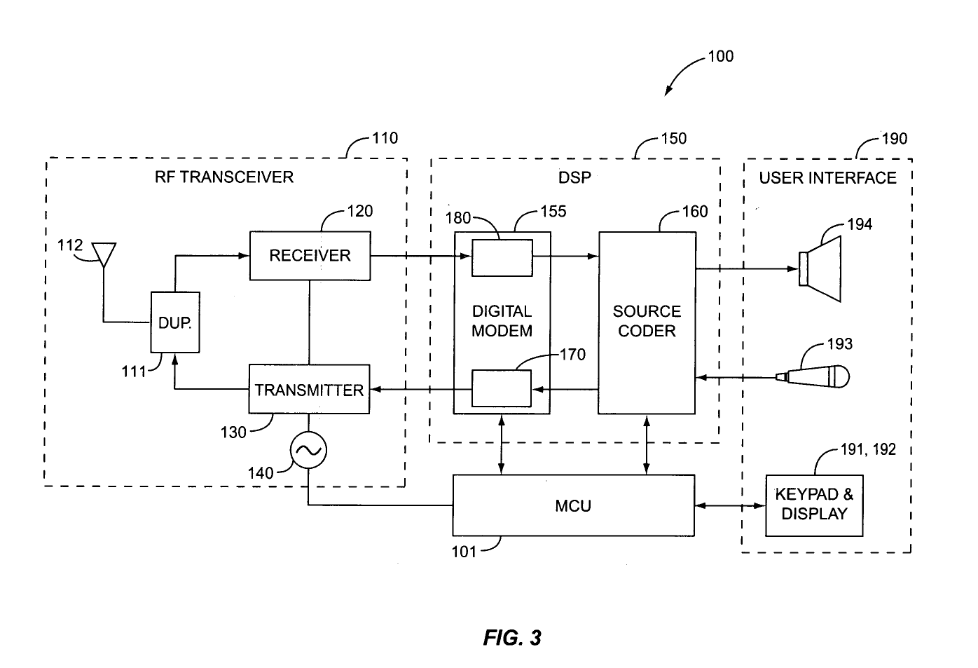

FIG. 3 is a block diagram of a mobile terminal 100. The term mobile terminal 100 as used herein includes a cellular radiotelephone; a Personal Digital Assistant (PDA) that may combine a cellular radiotelephone with data processing, facsimile and data communications capabilities; a conventional laptop and/or palmtop computer equipped with a radiotelephone transceiver, or other appliance that includes a radiotelephone transceiver. Mobile terminals 100 may also be referred to as “pervasive computing” devices.

Mobile terminal 100 is a fully functional mobile radio transceiver capable of transmitting and receiving signals over a RF channel. Exemplary standards that may be implemented by the mobile terminal 100 include, but are not limited to, cdma2000 and WCDMA. Mobile terminal 100 comprises a microcontroller unit (MCU) 101, a RF transceiver 110, a digital signal processor (DSP) 150, and a user interface 190. Mobile terminal 100 may additionally include an external interface for communication with a computer, local area network, or other device.

RF transceiver 110 establishes a link for wireless communications with the base station 12. RF transceiver 110 comprises a receiver 120, transmitter 130, frequency synthesizer 140, duplexer or switch 111, and antenna 112. Receiver 120 receives downlink or forward link communications from the base station 12. Receiver 120 amplifies and downconverts received signals to a baseband frequency for processing by the DSP 150. Transmitter 130 sends uplink or reverse link communications to the base station 12. Transmitter 130 receives baseband signals from the DSP 150, which the transmitter 130 amplifies and uses to modulate an RF carrier at a directed power level. Frequency synthesizer 140 provides the reference signals used for frequency translation in the receiver 120 and transmitter 130. Receiver 120 and transmitter 130 are coupled to antenna 112 by duplexer or switch 111. Duplexer 111 includes a duplex filter to isolate the transmitter 130 from the receiver 120. The duplex filter combines a transmit-band filter and receiver-band filter to provide the necessary isolation between the two paths.

DSP 150 comprises a digital modem 155 and source coder 160. Source coder 160 includes a speech coder (not shown) for digitizing and coding speech for transmission on the reverse link to the base station 12. Additionally, the speech coder decodes speech signals received from the base station 12 and converts speech signals into audio signals that are output to speaker 194. Speech is typically encoded at rates of 9.6 kilobits per second or 13.3 kilobits per second. The details of speech coding are not material to the invention and, therefore, are not explained in detail herein.

The digital modem 155 processes digital signals to make communication over the propagation channel more robust. Digital modem 155 includes a digital modulator 170 and at least one demodulator 180. The digital modulator 170 superimposes the message waveform onto a carrier for radio transmission using techniques that guard against fading and other impairments of the radio channel while attempting to maximize bandwidth efficiency. Modulator 170 also performs channel coding and encryption if used. The digital demodulator 180 detects and recovers the transmitted message. It tracks the received signal, estimates received signal strengths, rejects interference, and extracts the message data from noisy signals. Demodulator 180 also performs synchronization, channel decoding, and decryption if used.

The MCU 101 supervises the operation of the mobile terminal 100 and administers the procedures associated with the applicable communication protocol. The MCU 101 implements the communication protocols used by the mobile terminal 100. The communication protocol specifies timing, multiple access approach, modulation format, frame structure, power level, as well as many other aspects of mobile terminal operation. The MCU 101 inserts signaling messages into the transmitted signals and extracts signaling messages from the received signals. MCU 101 acts on signaling messages received from the base station 12 as set forth in the communication protocol. When the user enters commands via the user interface 190, the commands are passed to the MCU 101 for action.

The CDMA network 10 and mobile station 100 support soft handoffs as one means of reducing interference. A “handoff” occurs when a mobile station 100 moves between cells or sectors. In a traditional “hard” handoff, the connection to the current BTS 24 (the source base station) is broken and a connection is made with the new BTS 24 (the target base station) to resume communication with the mobile station 100. This is known as a “break before make” handoff. Because all cells or sectors in a CDMA system use the same frequency, it is possible to make the connection to the target BTS 24 before terminating the connection with the source BTS 24. This is known as a “make before break” or “soft” handoff. A soft handoff requires less power, which reduces interference and increases system capacity. A soft handoff is also more reliable (i.e., less dropped calls) because the new connection is made before the old connection is broken. Thus, a mobile station 100 may transmit simultaneously to more than one BTS 24. The BTSs 24 participating in a soft handoff for a given mobile station 100 are referred to as the active set of the mobile station 100.

During normal operation, a primary BTS 24 transmits a neighbor list to a mobile station 100 during call setup or following a handoff. The neighbor list may also be transmitted in idle state or in traffic state. The neighbor list identifies the neighboring cells in the proximity of the mobile station 100. The neighbor list includes a rescue flag that is set to “True” if the corresponding BTS 24 has rescue capability. The mobile station 100 measures the strength of pilot signals from the BTSs 24 on the neighbor list when it is in the traffic state and sends a pilot strength measurement message (PSMM) to the BTSs 24 in its active set. The PSMM may be sent periodically. The PSMM is forwarded to the BSC 22, which is responsible for making handoff decisions. Both the BTSs 24 and the mobile station 100 monitor the performance of the communication channel and can request handoffs. When a handoff is requested, the BSC 22 selects one or more target BTSs 24 to which the mobile station 100 is re-directed via a handoff direction message (HDM). When the mobile station 100 receives the handoff direction message, it begins transmitting traffic frames on the reverse link channel to the target BTSs 24 and transmits a handoff completion message (HCM) to the BTSs 24 in both the old and new active sets. The BSC 22 releases the BTSs 24 in the old active set when it has received the HCM from the mobile station 100.

There are circumstances where a mobile station 100 may fail to execute a handoff procedure when one is required. The failure to perform a handoff may be due to the BTS 24 failing to receive a PSMM from the mobile station 100, or the mobile station 100 failing to receive the handoff direction message. In such circumstances, the signal quality of the communication link between the mobile station 100 and the BTSs 24 in its active set may continue to deteriorate until the call is dropped.

The current cdma2000 standards include a rescue procedure to reestablish calls in danger of being dropped. The mobile station 100 disables its transmitter when it receives twelve consecutive bad frames on the forward link. The BTSs 24 in the mobile station's 100 active set detect the loss of signal from the mobile station 100. A BTS 24 detecting the loss of signal initiates a rescue procedure in order to reestablish the call before it is dropped.

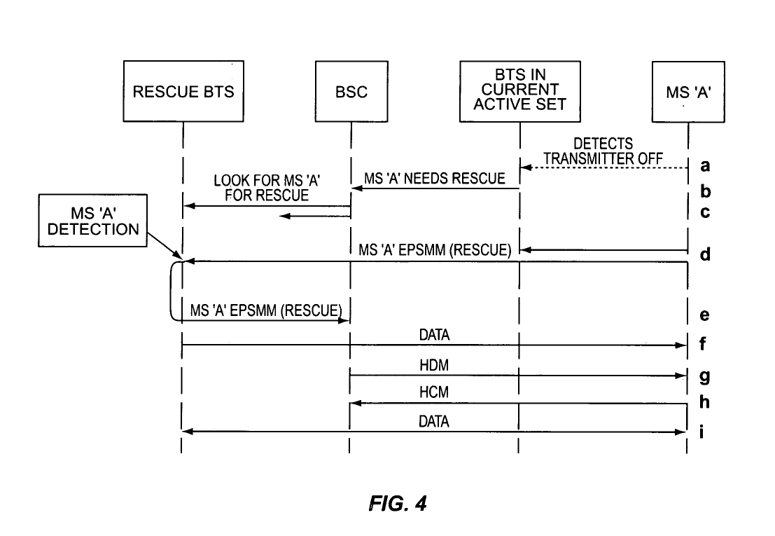

FIG. 4 illustrates an exemplary rescue procedure according to the cdma2000 standard. When a BTS 24 recognizes that a mobile station 100 has stopped transmitting (a), the BTS 24 sends a handoff request (b) to the BSC 22. The handoff request includes a flag that is set to indicate a rescue handoff. The BSC 22 selects one or more target BTSs 24 from the BTSs 24 identified in the PSMM from the mobile station 100. The BSC 22 sends a rescue notification message to the target BTSs 24 with rescue capability (c), referred to herein as rescue BTSs 24, to listen for the mobile station 100. These rescue BTSs 24 begin listening for the mobile station 100 but do not transmit frames on the forward link until mobile station 100 is acquired. After disabling its transmitter, the mobile station 100 autonomously promotes one or more BTSs 24 from its neighbor list with rescue capability into its active set, re-enables its transmitter, and starts transmitting reverse traffic frames (d) on a reverse traffic channel. The mobile station 100 also transmits an extended pilot strength measurement message (EPSMM) identifying the newly-promoted BTSs 24. If a rescue BTS 24 receives the reverse traffic frames and EPSMM from the mobile station 100, it transmits the reverse traffic frames and EPSMM received from the mobile station 100 to the base station controller 22 (e) and begins transmitting forward link frames to the mobile station 100 over the forward call recovery channel (f). The BSC 22 sends a handoff direction message (g) to the mobile station 100 over the forward call recovery channel to effect a handoff. The handoff direction message identifies the new active set for the mobile station 100. The new active set may include one or more BTSs from the old active set, but the Walsh codes for the traffic channels may be changed. After performing the handoff, the mobile station 100 sends a handoff completion message (HCM) to the BSC 22 (h), and begins transmitting on the reverse link channel to the BTSs 24 designated in the handoff direction message (i). When the handoff is completed, the call recovery channel is freed for use by another mobile station 100.

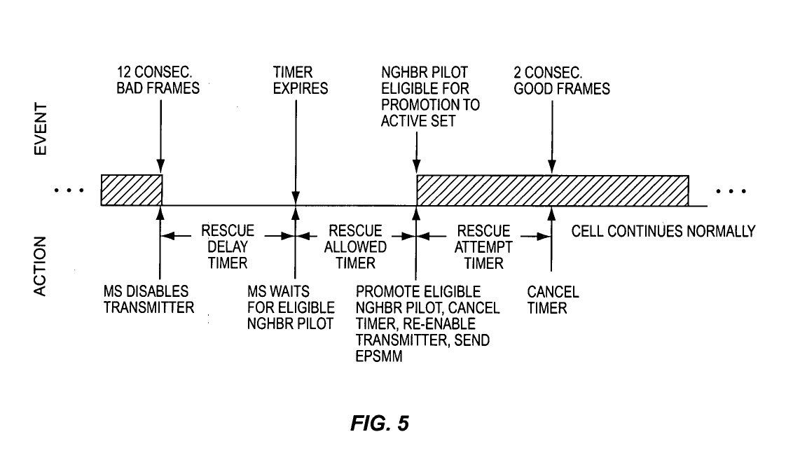

FIG. 5 is a timing diagram illustrating the timers the mobile station 100 uses to execute the rescue procedure. The BTS 24 sets the timer values, which include the rescue delay timer, the rescue allowed timer, and the rescue attempt timer. The rescue delay timer is activated when the mobile station 100 disables its transmitter. The purpose of the rescue delay timer is to give the BTS 24 time to set up resources for a rescue handoff after detecting that the mobile station 100 has turned off its transmitter. The rescue delay timer stops the mobile station 100 from turning on its transmitter before the call recovery channel is set up. The rescue allowed timer determines the amount of time the mobile stations 100 are allowed to look for eligible pilots at BTSs 24 with rescue capability. The mobile station 100 must turn on its transmitter and begin transmitting on a reverse traffic channel before this timer expires. The mobile station 100 turns on the rescue attempt timer when it begins transmitting on the reverse traffic channel. The rescue attempt timer limits the amount of time that the mobile station 100 transmits when it may not be receiving power control commands. The mobile station 100 aborts the rescue attempt when the rescue attempt timer expires.

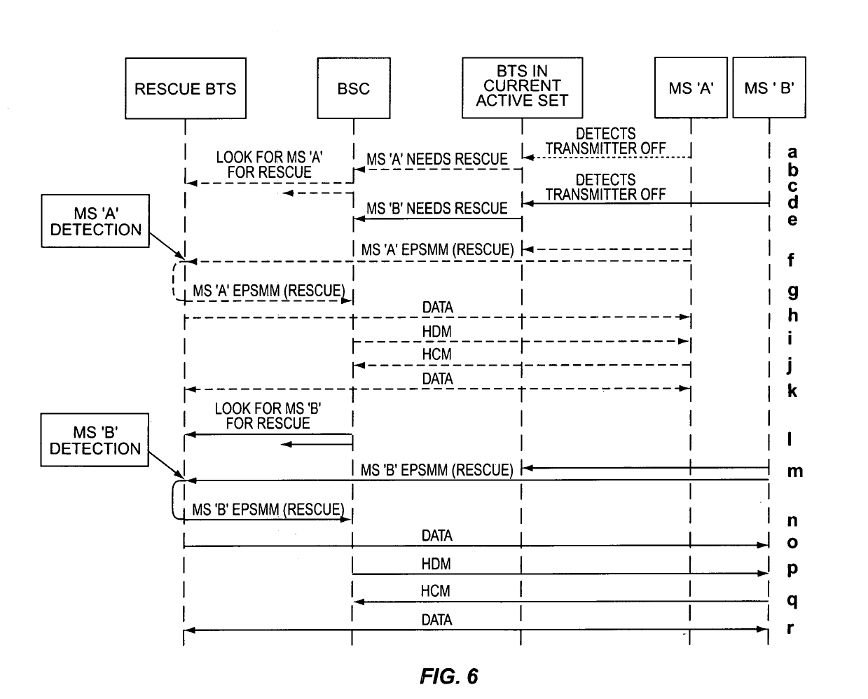

FIG. 6 illustrates a rescue procedure when two mobile stations 100, denoted mobile station A and mobile station B, are in need of rescue. When the BTS 24 recognizes that a mobile station A has stopped transmitting (a), the BTS 24 sends a handoff request (b) to the BSC 22 as previously described. The BSC 22 selects one or more rescue BTSs 24 from the BTSs 24 identified in the PSMM from the mobile station A and sends a rescue notification message to the selected bases stations 24 to notify them to listen for the mobile station A (c). After the signal from mobile station A is lost, the BTS 24 detects a loss of signal from mobile station B (d). The BTS 24 sends a second handoff request (e) to the BSC 22. The BSC 22, however, does not act immediately because the first rescue attempt is not yet completed.

Mobile station A autonomously promotes one or more BTSs 24 from its neighbor list into its active set, re-enables its transmitter, and starts transmitting an extended pilot strength measurement message (EPSMM) identifying the newly-promoted BTSs 24 (f). A rescue BTS 24 receiving an EPSMM with a rescue flag set forwards it to the BSC 22 (g) and begins transmitting forward link frames to the mobile station 100 on the forward call recovery channel (h). The BSC 22 sends a handoff direction message (i) to the mobile station 100 over the forward call recovery channel. After performing the handoff, the mobile station 100 sends a handoff completion message (HCM) to the BSC 22 (j) and begins transmitting and receiving on the channels assigned in the handoff direction message (k).

When the handoff of mobile station A is completed, the call recovery channel is freed for use to rescue mobile station B. The BSC 22 selects one or more target BTSs 24 from the BTSs 24 identified in the PSMM from the mobile station B and notifies the target BTSs 24 with rescue capability to listen for the mobile station B (l). Mobile station B, after expiration of the rescue delay timer, begins transmitting an EPSMM on a reverse link channel (m). Mobile station B may begin transmitting before the rescue of mobile station A is completed. If the rescue attempt timer expires before the rescue of mobile station A is complete, a link supervision mechanism in mobile station B will drop the call. Timers at the rescue base station will also expire after a predetermined time without detection of mobile station B and the rescue attempt will be abandoned.

Assuming that the rescue attempt is not abandoned, a rescue BTS 24 will eventually receive the EPSMM from mobile station B, notify the BSC 22 (n), and begin transmitting forward frames to mobile station B over the call recovery channel (o). The BSC 22 sends a handoff direction message to mobile station B (p), which in turn sends a handoff completion message back to the BSC 22 (q), and begins transmitting and receiving on the newly assigned channels (r).

The rescue procedure described above uses a dedicated forward link channel to reestablish communications with mobile stations 100 in danger of being dropped. Only a single mobile station 100 may be rescued at a time, which as described above may result in delays or in some calls being dropped when more than one mobile station 100 is in need of rescue. Because the resources allocated for rescue attempts are limited, the rescue procedure is initiated relatively infrequently to prevent tying up those resources for mobile stations 100 not truly in need of rescue.

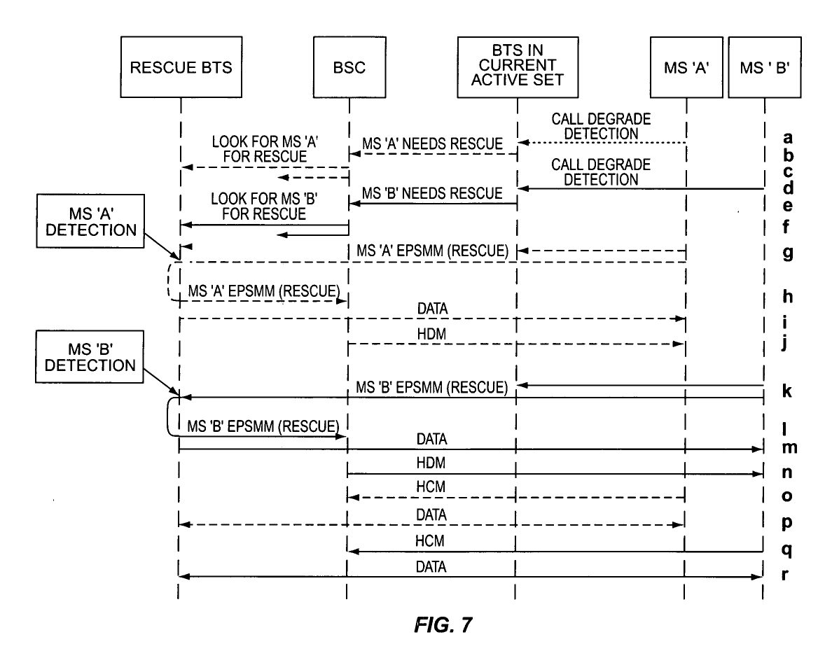

FIG. 7 illustrates a rescue procedure according to one embodiment of the present invention that allows simultaneous rescues of mobile stations 100 in danger of being dropped. The rescue procedure according to this embodiment employs a multiple access forward call recovery channel allowing the rescue of multiple mobile stations 100 at the same time using a single rescue channel. By using multiple access call recovery channel, a less conservative criteria can be employed to trigger rescue attempts since a single rescue attempt will not tie up all of the resources allocated for rescue of mobile stations 100. The more liberal criterion, in turn, results in faster recovery of mobile stations 100 that are in danger of being dropped.

In a preferred embodiment of the invention, a forward call recovery channel having multiple access capability is reserved for rescuing mobile stations 100 in danger of being dropped. The particular multiple access technique used is not important but it should be compatible with the communication standards employed. The call recovery channel may be a dedicated Walsh code channel reserved for rescue attempts. The BTSs 24 in the network may use the same Walsh code channel as a call recovery channel, or may use different Walsh code channels. The call recovery channel may be identified by a signaling message transmitted to the mobile stations 100 during call setup or following a handoff, or may be broadcast to mobile stations 100 over a broadcast channel.

In the exemplary embodiment described herein, the forward call recovery channel uses time division multiple access. With time division multiple access, a single Walsh code channel in the forward link can be used and divided into any number of time slots. Each time slot may comprise one or more frames and serves as a separate subchannel of the call recovery channel. In one exemplary embodiment, each time slot is composed of five 20 ms frames. Rescue messages directed to a particular mobile station 100 may be encoded using the target mobile station's long code as it is currently done on dedicated forward link channels. The term “rescue message” is used herein as a generic term to generally indicate signaling messages and data transmitted during a rescue procedure over the call recovery channel, as well as signaling messages transmitted by the mobile station 100 to the network 10. A mobile station 100 determines which messages are intended for it by the long code mask. If the mobile station's long code mask matches the one used to encode the message, the mobile station 100 knows that the message is intended for it. Because the long code mask identifies the mobile station 100 for which a rescue message is intended, a rescue message for any mobile station 100 can be sent at any time. The forward call recovery channel could, if desired, be gated off when there are no rescue messages to transmit. Alternatively, all of the time slots may be dedicated to a single mobile station 100 if there is only one mobile station 100 in need of rescue. In this case, the BTS 24 does not reserve resources for rescue of a second mobile station 100 until rescue of the second mobile station is required. Thus, dynamic allocation of resources is possible.

FIG. 7 illustrates a rescue procedure using the multiple access call recovery channel according to one embodiment of the present invention. A BTS 24 in the active set of mobile station A detects a loss or degradation in the signal from mobile station A (a), and transmits a rescue handoff request to BSC 22 (b). The BSC 22 selects one or more nearby BTSs 24 with rescue capabilities and sends a rescue notification message to selected rescue BTSs 24 (c) to notify them to listen for transmissions from mobile station A. Before mobile station A is rescued, the same or another BTS 24 detects a loss or degradation in the signal from mobile station B (d) and transmits a second rescue handoff request to the BSC 22 (e). The BSC 22 selects one or more nearby BTSs 24 with rescue capabilities and notifies them to listen for transmissions from mobile station B (f). It should be noted that, with the present invention, the rescue BTSs 24 selected for mobile station B may include one or more of the rescue BTSs 24 selected for mobile station A. Thus, a single BTS 24 may participate in the simultaneous rescue of multiple mobile stations 100.

After the rescue procedure is triggered, mobile station A autonomously promotes one or more BTSs 24 in its neighbor list with rescue capability into its active set, and begins transmitting an EPSMM over a reverse traffic channel to the promoted BTSs 24 (g). The EPSMM is transmitted periodically, until the rescue attempt timer expires. A rescue BTS 24 detects the EPSMM from mobile station A, forwards the EPSMM to the BSC 22 (h), and begins transmitting forward link frames to mobile station A (i). Transmission of forward link frames could, alternatively, begin before the EPSMM from the mobile station is received. The rescue BTS 24 transmits the forward link frames in a first selected time slot on the call recovery channel, which may be specified by the BSC 22 in the rescue notification message. The BSC 22 transmits a handoff direction message to mobile station A (j) in the selected time slot identifying one or more target BTSs 24 for a handoff. The target BTSs 24 are selected based on the EPSMM from the mobile station A. When the handoff direction message is transmitted, the BTS 24 stops transmitting traffic frames on the call recovery channel, and begins transmitting on the assigned forward link traffic channel.

Before the handoff from mobile station A is complete, mobile station B begins transmitting an EPSMM to newly promoted BTSs 24 from its neighbor list on a reverse traffic channel (k). A rescue BTS 24 detects an EPSMM from mobile station B, forwards the EPSMM to the BSC 22 (l) and begins transmitting forward link frames on a second selected time slot on the forward call recovery channel (m). The BSC 22 sends a handoff direction message to mobile station B (n) in the selected time slot directing mobile station B to handoff to one or more target BTSs 24 determined based on the EPSMM for mobile station B. After the rescue of mobile station B is initiated, the mobile station A sends a handoff completion message to BSC 22 (o) and begins transmitting and receiving data on the newly assigned channels (p). Mobile station B also transmits a handoff completion message to BSC 22 (q) and begins transmitting and receiving on its newly assigned channels (r). After receiving the handoff completion message from mobile station A and B, the BSC 22 sends a drop message to the rescue BTS 24 not in the new active sets for the mobile stations A and B.

As shown in FIG. 7, a rescue BTS 24 may participate in the rescue of multiple mobile stations 100. One benefit is that the rescue of mobile station B does not have to be delayed until the rescue attempt of mobile station A is complete. Using multiple access call recovery channels therefore allows the rescue of mobile station B sooner than would otherwise be possible using conventional rescue procedures, which may prevent mobile station B from dropping the call before it can be rescued.

The selection of time slots for different mobile stations 100 can be done in any suitable way. The BSC 22 may arbitrarily assign time slots to the mobile stations 100, or a hashing algorithm may be used to assign time slots. For example, the electronic serial number (ESN) of the mobile station 100 could be hashed to determine the time slot. In this case, the hash could be performed separately by the BSC 22 and the mobile station 100.

The rescue procedure can be further speeded up by using more liberal criteria for triggering the rescue procedure and using explicit signaling from the mobile station 100 to trigger the rescue procedure. For example, the mobile station 100 may maintain a counter for the frame error rate (FER) at the mobile station 100. The BTS 24 in this exemplary embodiment provides the mobile station 100 with two FER thresholds. The thresholds may, for example, be a specified number of frame erasures in a measurement window. When the first FER threshold is reached, the mobile station 100 transmits an EPSMM with an explicit indication that the first threshold is reached to the BTSs 24 in its active set to notify the BTSs 24 that it is in danger of being dropped. The explicit indication in the EPSMM in this case could comprise a rescue parameter that is set to alert the BTSs 24 in its active set that it is near the point of needing a rescue so that the BSC 22 can allocate rescue resources at rescue capable BTSs 24. The BSC 22 upon receipt of the EPSMM indicating that the first threshold has been crossed would notify selected rescue BTSs 24 to begin listening to the mobile station 100 on the reverse traffic channel, but not transmit on the forward rescue channel until receipt of the EPSMM indicating that the second threshold has been crossed. The EPSMM is a rescue message. The mobile station 100 may then select BTSs 24 in nearby cells from its neighbor list in anticipation of further deterioration of its signal. The BTSs 24 receiving the EPSMM notify the BSC 22 that the mobile station 100 may be in need of rescue, and BSC 22 would select one or more rescue BTSs 24 as previously described. In this exemplary embodiment, the mobile station 100 would not initiate the rescue procedure until the second FER threshold is reached. Once the second FER threshold is reached, the mobile station 100 can immediately promote the selected BTSs 24 with rescue capability from its neighbor list and begin transmitting a second EPSMM with an explicit indication that the second threshold has been reached. The explicit indication may comprise a rescue parameter that is set to indicate that it requires rescuing. The second EPSMM is a rescue message. When a rescue BTS 24 receives this message, it notifies the BSC 22 which sends a handoff direction message over the multiple access call recovery channel, and the mobile station 100 performs a handoff as previously described. If the FER at the mobile station 100 does not reach the second threshold, timers in the rescue BTSs 24 would expire after a predetermined time. The early release of the reverse call recovery channel is not critical since multiple mobile stations 100 can be rescued simultaneously.

The use of two thresholds enables early setup of rescue BTSs 24 to begin listening to the mobile station 100 that is close to being dropped if it crosses the first threshold without consuming any air-interface capacity since the mobile station 100 is still on the traffic channel and is transmitting to its current active set. Only if the second threshold is crossed, does the rescue BTSs 24 begin transmitting to the mobile station 100, although resources for the rescue BTS 24 were allocated by the BSC 22 when the first threshold was crossed. This avoids unnecessary transmissions on the forward rescue channel should the call recover by itself due to the mobile station 100 moving into a better location, or the channel conditions improving such that the mobile station 100 is able to perform a soft handoff to the optimal active set

Using a multiple access call recovery channel allows a more liberal criteria for triggering a rescue. Consequently, mobile stations in danger of being dropped can be rescued more quickly. Faster rescues reduce interference on the forward and reverse links and increase system capacity. A mobile station in danger of being dropped is likely to have a sub-optimal active set on the reverse link, which causes the mobile station to transmit with a higher transmit power than is necessary. Thus, the mobile station generates more interference on the reverse link. Similarly, a sub-optimal active set on the forward link causes the base stations serving the mobile station to transmit at higher power levels generating more interference on the forward link. The increase in interference on the forward and reverse links reduces system capacity. Reducing the interference generated by the mobile station therefore will increase system capacity.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of call recovery in a wireless communication network, comprising:
reserving a forward link channel for use as a call recovery channel;
configuring the call recovery channel for simultaneous rescue of multiple mobile stations; and
multiplexing rescue messages for multiple mobile stations onto the call recovery channel for transmission to mobile stations in need of rescue.

2. The method of claim 1 wherein the call recovery channel is a dedicated channel.

3. The method of claim 1 wherein the call recovery channel is a dedicated Walsh code channel.

4. The method of claim 1 wherein configuring the call recovery channel for simultaneous rescue of multiple mobile stations comprises dividing the call recovery channel into a plurality of time slots.

5. The method of claim 4 wherein multiplexing rescue messages for multiple mobile stations onto the call recovery channel for transmission to mobile stations in need of rescue comprises transmitting rescue messages for different mobile stations in different time slots.

6. The method of claim 5 wherein multiplexing rescue messages for multiple mobile stations onto the call recovery channel for transmission to mobile stations in need of rescue further comprises encoding each rescue messages with a code associated with a target mobile station.

7. The method of claim 5 wherein transmitting rescue messages for different mobile stations in different time slots comprises selecting a time slot for each mobile station in need of rescue.

8. The method of claim 7 wherein time slots are selected based on the product of a hashing algorithm.

9. A base station in a mobile communication network having rescue capability, comprising:
transceivers for communicating with one or more mobile stations over forward and reverse link channels;
a forward call recovery channel for communicating with mobile stations in need of rescue, said forward call recovery channel configured for simultaneous use by multiple mobile stations; and
a control unit operatively connected to the transceivers for multiplexing rescue messages to mobile stations in need of rescue onto the forward call recovery channel.

10. The base station of claim 9 wherein the forward call recovery channel is a dedicated channel.

11. The method of claim 10 wherein the call recovery channel is a dedicated Walsh code channel.

12. The base station of claim 9 wherein the call recovery channel is divided into a plurality of time slots.

13. The base station of claim 12 wherein the control unit multiplexes rescue messages onto the call recovery channel by transmitting rescue messages for different mobile stations in different time slots.

14. The base station of claim 13 wherein the control unit encodes rescue messages with a code corresponding to a target mobile station.

15. The base station of claim 13 wherein the control unit selects a time slot for each mobile station in need of rescue.

16. The base station of claim 15 wherein the control unit selects time slots for mobile stations based on the product of a hashing algorithm.

17. A method of call recovery in a wireless communication network, comprising:
monitoring a signal quality indicator at a mobile station;
comparing the signal quality indicator to first and second thresholds;
transmitting a first rescue message to a first base station in response to the signal quality indicator reaching a first threshold; and
autonomously promoting one or more base stations into the mobile station's active set and sending a second rescue message to the first base station in response to the signal quality indicator reaching the second threshold; and
transmitting signals to the newly promoted base stations.

18. The method of claim 17 wherein the first rescue message is a pilot strength measurement message.

19. The method of claim 18 wherein the pilot strength measurement message includes an explicit indication that the first threshold has been reached.

20. The method of claim 17 wherein the second rescue message is a pilot strength measurement message including pilot strength measurements for the newly promoted base stations.

21. The method of claim 20 wherein the pilot strength measurement message includes an explicit indication that the second threshold has been reached.

22. A mobile station comprising:
a transceiver for communicating with one or more base stations in a mobile communication network; and
a control unit operatively connected to the transceiver for:
monitoring a signal quality indicator at a mobile station;
comparing the signal quality indicator to first and second thresholds;
transmitting a first rescue message to a first base station in response to the signal quality indicator reaching a first threshold; and
autonomously promoting one or more base stations into the mobile station's active set when the second threshold is reached and sending a second rescue message to the first base station in response to the signal quality indicator reaching the second threshold; and
transmitting signals to the newly promoted base stations.

23. The mobile station of claim 22 wherein the first rescue message is a pilot strength measurement message.

24. The mobile station of claim 23 wherein the pilot strength measurement message includes an explicit indication that the first threshold has been reached.

25. The mobile station of claim 22 wherein the second rescue message is a pilot strength measurement message including pilot strength measurements for the newly promoted base stations.

26. The method of claim 25 wherein the pilot strength measurement message includes an explicit indication that the first threshold has been reached.

27. A method of call recovery in a wireless communication network, comprising:
receiving an explicit rescue message from a mobile station at a base station; and
initiating a rescue procedure responsive to the explicit rescue message from the mobile station.

28. A method of call recovery comprising:
reserving a forward link channel for use as a call recovery channel;
configuring the call recovery channel for simultaneous rescue of multiple mobile stations;
detecting multiple mobile stations in need of rescue; and
for each mobile station:
selecting one or more rescue base stations notifying one or more rescue base stations to listen for transmissions from the mobile station;
receiving a pilot strength measurement message from the mobile station at a rescue base station; and
sending a handoff direction message to the mobile station over the forward call recovery channel.

29. The method of claim 28 wherein detecting multiple mobile stations in need of rescue comprises detecting a loss of signal from the mobile stations.

30. The method of claim 28 wherein detecting multiple mobile stations in need of rescue comprises receiving a rescue message from the mobile stations.

31. The method of claim 28 wherein detecting multiple mobile stations in need of rescue comprises detecting a quality of the communication link from the mobile stations.

32. The method of claim 28 wherein the call recovery channel is a dedicated channel.

33. The method of claim 32 wherein the call recovery channel is a Walsh code channel.

34. The method of claim 28 wherein configuring the call recovery channel for simultaneous rescue of multiple mobile stations comprises dividing the call recovery channel into a plurality of time slots.

35. The method of claim 28 wherein sending a handoff direction message to the mobile station over the forward call recovery channel, comprises multiplexing rescue messages for multiple mobile stations onto the call recovery channel for transmission to mobile stations in need of rescue.

36. The method of claim 35 wherein multiplexing rescue messages for multiple mobile stations onto the call recovery channel for transmission to mobile stations in need of rescue comprises transmitting rescue messages for different mobile stations in different time slots.

37. The method of claim 36 wherein multiplexing rescue messages for multiple mobile stations onto the call recovery channel for transmission to mobile stations in need of rescue further comprises encoding each rescue messages with a code associated with a target mobile station.

38. The method of claim 36 wherein transmitting rescue messages for different mobile stations in different time slots comprises selecting a time slot to each mobile station in need of rescue.

39. The method of claim 38 wherein time slots are selected based on the product of a hashing algorithm.
